(19) United States
(12) Patent Application Publication
(10) Pub. No.: US 2026/0069067 A1
(43) Pub. Date: Mar. 12, 2026

(54) FEEDER FOR PACKAGED FOOD

(71) Applicant: Yancheng Paiwelya Pet Food Co., Lid., Yancheng City (CN)

(72) Inventor: Peng QIU, Yancheng City (CN)

(21) Appl. No.: 19/027,294

(22) Filed: Jan. 17, 2025

(30) Foreign Application Priority Data
Sep. 11, 2024 (CN) 202422226388.9

(51) Int. Cl. A01K 5/015

(52) U.S. Cl. CPC A47G 21/00; A61J 7/0023

(57) ABSTRACT

Provided is a feeder for a packaged food, pertaining to the technical field of pet products. The feeder includes a housing and a coupling element. The housing includes a food storage area and an accommodating area in communication with the food storage area. The coupling element is attached to the housing, and is configured to hold a food package in the accommodating area. Food squeezed out of the food package by a user can be stored in the food storage area for a pet to lick. As such, the user will not get his or her hands dirty with food.

### CROSS REFERENCE TO THE RELATED APPLICATIONS

This application is based upon and claims priority to Chinese Patent Application No. 202422226388.9, filed on Sep. 11, 2024, the entire contents of which are incorporated herein by reference.

### TECHNICAL FIELD

The present disclosure belongs to the technical field of pet supplies, and specifically relates to a feeder for a packaged food.

### BACKGROUND

Packaged food is generally packaged in an elongated plastic food package, and given to pets as a treat. The food package has a tearable notch at an end. After the food package is torn from the tearable notch, the food in the food package can be squeezed out for pets to lick. However, the pet keeper often squeezes out too much food and gets his/her hands dirty.

### SUMMARY

An objective of the present disclosure is to provide a feeder for a packaged food to solve the above problems in the prior art.

A feeder for a packaged food is provided, which includes a housing and a coupling element. The housing includes a food storage area and an accommodating area in communication with the food storage area. The coupling element is attached to the housing, and is configured to hold a food package in the accommodating area.

In an embodiment of the present disclosure, the housing includes a bottom wall and a side wall attached to an edge of the bottom wall.

In an embodiment of the present disclosure, the bottom wall has a first shape and a second shape, the food storage area is defined between the bottom wall of the first shape and the side wall, and the accommodating area is defined between the bottom wall of the second shape and the side wall.

In an embodiment of the present disclosure, the first shape is one of a circle-like shape, an elongated shape, an ellipse-like shape, and a polygonal shape.

In an embodiment of the present disclosure, the second shape is an elongated shape.

In an embodiment of the present disclosure, the coupling element includes a fixing strip, and an end of the fixing strip is attached to a side portion of the housing.

In an embodiment of the present disclosure, a first end of the fixing strip is releasably attached to a first side portion of the housing, and a second end of the fixing strip is releasably attached to a second side portion of the housing.

In an embodiment of the present disclosure, a first end of the fixing strip is pivotally attached to a first side portion of the housing, and a second end of the fixing strip is releasably attached to a second side portion of the housing.

In an embodiment of the present disclosure, the coupling element further includes a hole and a protrusion, the hole is provided on the housing, a first end of the protrusion is attached to an interior of the hole, and a second end of the protrusion protrudes out of the hole.

In an embodiment of the present disclosure, a groove is provided on the side portion of the housing, and the end of the fixing strip is located in the groove.

In an embodiment of the present disclosure, the feeder further includes a squeezing element attached to the housing, where the squeezing element is movable between an initial position and a final position relative to the housing.

In an embodiment of the present disclosure, the squeezing element includes a squeezing block, an end of the squeezing block is slidably attached to the side portion of the housing, and a gap is defined between the end of the squeezing block and the side portion of the housing.

In an embodiment of the present disclosure, the squeezing block includes a guide section at a bottom thereof, the second end of the protrusion protruding out of the hole presses against a starting end of the guide section, and the guide section is configured to guide the squeezing block to move upward.

In an embodiment of the present disclosure, a terminal end of the guide section smoothly transitions with a surface of the bottom of the squeezing block.

In an embodiment of the present disclosure, a surface of the guide section from the starting end to the terminal end is a convex curved surface.

In an embodiment of the present disclosure, a surface of the guide section from the starting end to the terminal end is an inclined surface.

In conclusion, the present disclosure has the following advantages.

1. According to the feeder for the packaged food of the present disclosure, the coupling element holds a food package in the accommodating area, and food squeezed out of the food package by a user can be stored in the food storage area for a pet to lick. As such, the user will not get his or her hands dirty with food.

2. According to the feeder for the packaged food of the present disclosure, when the user pushes the squeezing element to move from the initial position to the final position, the squeezing element can apply radial pressure to the food package, so as to squeeze food out of the food package.

3. According to the feeder for the packaged food of the present disclosure, the gap is defined between the end of the squeezing block and the side portion of the housing, so that when axial pressure is applied to the squeezing block, the squeezing block can tightly fit to the food package to squeeze out all the food, so that no food is left in the food package and wasted.

4. According to the feeder for the packaged food of the present disclosure, the second end of the protrusion protruding out of the hole presses against the starting end of the guide section, and the guide section is configured to guide the squeezing block to move upward, so that the squeezing block can be smoothly moved onto the food package, and then be pushed by the user to squeeze the food out of the food package.

### BRIEF DESCRIPTION OF THE DRAWINGS

FIG. 1 is a schematic view of a feeder according to an embodiment.

FIG. 2 is a cross-sectional view of the feeder shown in FIG. 1.

FIG. 3 is a schematic view of a feeder according to an embodiment.

FIG. 4 is a cross-sectional view of the feeder shown in FIG. 3.

FIG. 5 is another cross-sectional view of the feeder shown in FIG. 3.

FIG. 6 is a schematic view of a squeezing block of the feeder shown in FIG. 3.

In the drawings, reference numerals respectively represent: 1. housing; 10. bottom wall; 11. side wall; 2. food storage area; 3. accommodating area; 40. fixing strip; 5. groove; 60. hole; 61. protrusion; 70. squeezing block; 701. guide section; 8. gap.

### DETAILED DESCRIPTION OF THE EMBODIMENTS

In the following description, numerous specific details are given to provide a more thorough understanding of the present disclosure. However, it will be apparent to those skilled in the art that the present disclosure can be practiced without one or more of these details. In some other examples, to avoid confusion with the present disclosure, some technical features well known in the art are not described.

### Embodiment 1

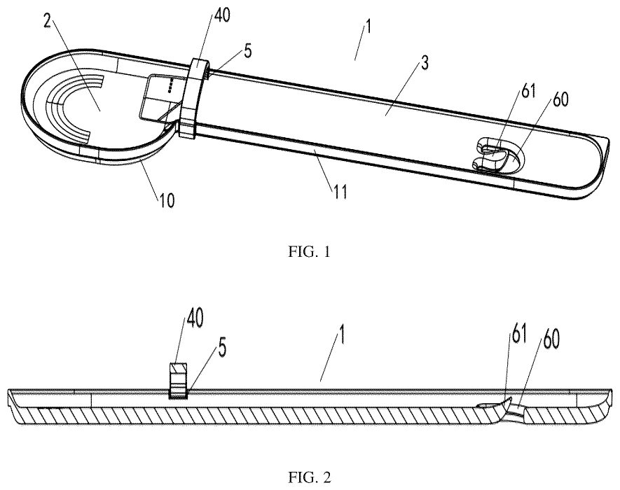

As shown in FIG. 1, this embodiment discloses a feeder for a packaged food, which includes a housing 1 and a coupling element. The housing 1 includes a food storage area 2 and an accommodating area 3 in communication with the food storage area 2. The coupling element is attached to the housing 1, and is configured to hold a food package in the accommodating area 3. Food squeezed out of the food package by a user can be stored in the food storage area 2 for a pet to lick. As such, the user will not get his or her hands dirty with food.

As shown in FIG. 1, the housing 1 includes a bottom wall 10 and a side wall 11 attached to an edge of the bottom wall 10. The bottom wall 10 has a first shape and a second shape. The food storage area 2 is defined between the bottom wall 10 of the first shape and the side wall 11. The accommodating area 3 is defined between the bottom wall 10 of the second shape and the side wall 11.

As shown in FIG. 1, the first shape is an ellipse-like shape and the second shape is an elongated shape.

As shown in FIG. 1, the coupling element includes a fixing strip 40. A first end of the fixing strip 40 is releasably attached to a first side portion of the housing 1. A second end of the fixing strip 40 is releasably attached to a second side portion of the housing 1. The fixing strip 40 is configured to press a first end of the food package which has a tearable notch into the accommodating area 3.

As shown in FIG. 1, grooves 5 are respectively provided on the first side portion and the second side portion of the housing 1, the first end and the second end of the fixing strip 40 are respectively located in the grooves 5, and the grooves 5 can restrict a radial movement of the fixing strip 40.

As shown in FIG. 1 and FIG. 2, the coupling element further includes a hole 60 and a protrusion 61. The hole 60 is provided on the housing 1, a first end of the protrusion 61 is attached to an interior of the hole 60, a second end of the protrusion 61 protrudes out of the hole 60, and a second end of the food package is wrapped over and fixed by the protrusion 61, so that the food package is held in the accommodating area 3 by the protrusion 61 and the fixing strip 40.

### Embodiment 2

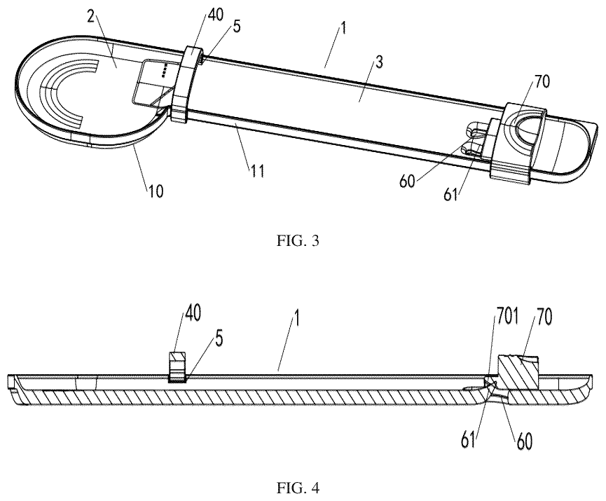

As shown in FIG. 3, this embodiment discloses a feeder for a packaged food, which includes a housing 1, a coupling element, and a squeezing element. The housing 1 includes a food storage area 2 and an accommodating area 3 in communication with the food storage area 2. The coupling element is attached to the housing 1, and is configured to hold a food package in the accommodating area 3. The squeezing element is attached to the housing 1, and is movable between an initial position and a final position relative to the housing 1. When a user pushes the squeezing element to move from the initial position to the final position, the squeezing element can apply radial pressure to the food package, so as to squeeze food out of the food package.

As shown in FIG. 1, the housing 1 includes a bottom wall 10 and a side wall 11 attached to an edge of the bottom wall 10. The bottom wall 10 has a first shape and a second shape. The food storage area 2 is defined between the bottom wall 10 of the first shape and the side wall 11. The accommodating area 3 is defined between the bottom wall 10 of the second shape and the side wall 11.

As shown in FIG. 1, the first shape is an ellipse-like shape and the second shape is an elongated shape.

As shown in FIG. 1, the coupling element includes a fixing strip 40. A first end of the fixing strip 40 is releasably attached to a first side portion of the housing 1. A second end of the fixing strip 40 is releasably attached to a second side portion of the housing 1. The fixing strip 40 is configured to press a first end of the food package which has a tearable notch into the accommodating area 3.

As shown in FIG. 1, grooves 5 are respectively provided on the first side portion and the second side portion of the housing 1, the first end and the second end of the fixing strip 40 are respectively located in the grooves 5, and the grooves 5 can restrict a radial movement of the fixing strip 40.

As shown in FIG. 1 and FIG. 2, the coupling element further includes a hole 60 and a protrusion 61. The hole 60 is provided on the housing 1. A first end of the protrusion 61 is attached to an interior of the hole 60. A second end of the protrusion 61 protrudes out of the hole 60.

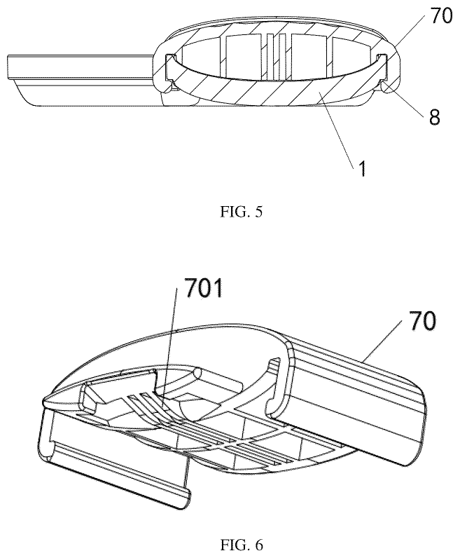

As shown in FIG. 3 and FIG. 5, the squeezing element includes a squeezing block 70. A first end of the squeezing block 70 is slidably attached to the first side portion of the housing 1, a second end of the squeezing block 70 is slidably attached to the second side portion of the housing 1, a gap 8 is defined between the first end of the squeezing block 70 and the first side portion of the housing 1, and another gap 8 is defined between the second end of the squeezing block 70 and the second side portion of the housing 1. When axial pressure is applied to the squeezing block 70, the squeezing block 70 can tightly fit to the food package to squeeze out all the food, so that no food is left in the food package and wasted.

As shown in FIG. 4 and FIG. 6, the squeezing block 70 includes a guide section 701 at a bottom thereof. The second end of the protrusion 61 protruding out of the hole 60 presses against a starting end of the guide section 701. The guide section 701 is configured to guide the squeezing block 70 to move upward, so that the squeezing block 70 can be smoothly moved onto the food package, and then be pushed by the user to squeeze the food out of the food package, while avoiding positional interference with the protrusion 61.

As shown in FIG. 6, a terminal end of the guide section 701 smoothly transitions with a surface of the bottom of the squeezing block 70.

As shown in FIG. 6, a surface of the guide section 701 from the starting end to the terminal end is a convex curved surface.

Preferred embodiments of the present disclosure have been described in detail above in conjunction with the accompanying drawings, but the present disclosure is not limited to the specific details in the above embodiments. Various equivalent modifications can be made to the technical solutions of the present disclosure without departing from the scope of the technical concept of the present disclosure. Such equivalent modifications shall all fall within the protection scope of the present disclosure.

What is claimed is:

1. A feeder for a packaged food, comprising: a housing, wherein the housing comprises a food storage area and an accommodating area, and the accommodating area is in communication with the food storage area; and
a coupling element, wherein the coupling element is attached to the housing, and
the coupling element is configured to hold a food package in the accommodating area.

2. The feeder for the packaged food according to claim 1, wherein the coupling element comprises a fixing strip, and an end of the fixing strip is attached to a side portion of the housing.

3. The feeder for the packaged food according to claim 2, wherein the coupling element further comprises:
a hole, wherein the hole is provided on the housing; and
a protrusion, wherein a first end of the protrusion is attached to an interior of the hole, and a second end of the protrusion protrudes out of the hole.

4. The feeder for the packaged food according to claim 2, wherein a groove is provided on the side portion of the housing, and the end of the fixing strip is located in the groove.

5. The feeder for the packaged food according to claim 3, further comprising a squeezing element attached to the housing, wherein the squeezing element is movable between an initial position and a final position relative to the housing.

6. The feeder for the packaged food according to claim 5, wherein the squeezing element comprises a squeezing block, an end of the squeezing block is slidably attached to the side portion of the housing, and a gap is defined between the end of the squeezing block and the side portion of the housing.

7. The feeder for the packaged food according to claim 6, wherein the squeezing block comprises a guide section at a bottom of the squeezing block, the second end of the protrusion protruding out of the hole presses against a starting end of the guide section, and the guide section is configured to guide the squeezing block to move upward.

8. The feeder for the packaged food according to claim 7, wherein a terminal end of the guide section smoothly transitions with a surface of the bottom of the squeezing block.

9. The feeder for the packaged food according to claim 8, wherein a surface of the guide section from the starting end to the terminal end is a convex curved surface.
